(19) United States
(12) Patent Application Publication
(10) Pub. No.: US 2025/0010923 A1
(43) Pub. Date: Jan. 9, 2025

(54) VEHICLE

(71) Applicant: TOYOTA JIDOSHA KABUSHIKI KAISHA, Toyota-shi (JP)

(72) Inventors: Koji OGAWA, Toyota-shi (JP); Takahiro SHIOKAWA, Susono-shi (JP)

(73) Assignee: TOYOTA JIDOSHA KABUSHIKI KAISHA, Toyota-shi (JP)

(21) Appl. No.: 18/754,357

(22) Filed: Jun. 26, 2024

(30) Foreign Application Priority Data
Jul. 5, 2023 (JP) 2023-110662

(51) Int. Cl. B62D 25/20; B60K 1/04; B60N 2/015; B62D 21/02; B62D 27/02

(52) U.S. Cl. CPC B62D 25/2009; B60N 2/015; B62D 21/02; B62D 27/02; B60K 1/04; B60K 2001/0438

(57) ABSTRACT

A vehicle includes: a floor panel; a first crossmember that extends in a vehicle left-right direction along the floor panel; a second crossmember that extends in the vehicle left-right direction along the floor panel and is positioned rearward of the first crossmember in a vehicle front-rear direction; a joining member that extends in the vehicle front-rear direction along the floor panel and joins the first crossmember and the second crossmember to each other; and a seat bracket which is provided in the joining member and on which a seat for a user to sit on is fixed.

### CROSS-REFERENCE TO RELATED APPLICATION

This application claims priority to Japanese Patent Application No. 2023-110662 filed on Jul. 5, 2023 incorporated herein by reference in its entirety.

### BACKGROUND

### 1. Technical Field

A technology disclosed by the present specification relates to a vehicle.

### 2. Description of Related Art

In Japanese Unexamined Patent Application Publication No. 2001-328569, a vehicle is described. In this vehicle, an inner belt anchor with which a tongue plate of a seatbelt is locked is fixed to a floor panel. A crossmember and a reinforcement are provided on the floor panel, and a fixing section of the inner belt anchor is joined to the crossmember via the reinforcement. According to the configuration as above, a deformation that occurs in the floor panel is reduced even when a great load is applied to the seatbelt.

### SUMMARY

In vehicles in recent years, one end or both ends of a seatbelt is or are fixed to a seat in many cases. In such a configuration, when a great load is applied to the seatbelt, there is a fear that a great load may be applied to a fixing section (hereinafter referred to as a seat fixing section) of the seat with respect to the floor panel and a deformation may occur in the floor panel. In the present specification, a technology for improving the strength of the seat fixing section is provided.

A technology disclosed in the present specification is embodied by a vehicle. In a first aspect, a vehicle includes: a floor panel; a first crossmember that extends in a vehicle left-right direction along the floor panel; a second crossmember that extends in the vehicle left-right direction along the floor panel and is positioned rearward of the first crossmember in a vehicle front-rear direction; a joining member that extends in the vehicle front-rear direction along the floor panel and joins the first crossmember and the second crossmember to each other; and a seat bracket which is provided in the joining member and on which a seat for a user to sit on is fixed. Here, the seat may be directly fixed to the seat bracket or the seat may be indirectly fixed to the seat bracket via a seat rail and the like.

In the vehicle described above, the seat bracket to which the seat is fixed is provided in the joining member that joins the first crossmember and the second crossmember to each other. According to the configuration as above, a seat fixing section in the floor panel is reinforced by the joining member and the two crossmembers, and hence it becomes possible to reduce the deformation caused in the floor panel and the like. When a side collision occurs in the vehicle and a load is applied to one of the two crossmembers from the vehicle left-right direction, the load is also transmitted to the other of the crossmembers via the joining member. Therefore, it becomes possible to improve the strength of the vehicle against a side collision.

In a second aspect, the vehicle may further include a battery pack positioned on the lower side of the floor panel in a vehicle-height direction in the first aspect. In this case, the first crossmember and the second crossmember may be positioned rearward of the battery pack in the vehicle front-rear direction and be provided along a lower surface of the floor panel. According to the configuration as above, it becomes possible to relatively widen the space of a vehicle cabin provided on the upper side the floor panel.

In a third aspect, the vehicle may further include a reinforcement plate disposed along the vehicle left-right direction on the inside of the first crossmember and joined to the first crossmember in the first or second aspect. According to the configuration as above, it becomes possible to improve the rigidity and the strength of the first crossmember. Therefore, it becomes possible to support the seat in a more stable manner, and it becomes possible to improve the absorption of the collision energy by the first crossmember when a side collision occurs in the vehicle.

In a fourth aspect, the vehicle may further include: a third crossmember that extends in the vehicle left-right direction along an upper surface of the floor panel on the upper side of the battery pack in the vehicle-height direction; and a second seat bracket which is provided in the third crossmember and on which the seat is fixed in any of the first to third aspects. According to the configuration as above, the front end portion of the seat is supported by the third crossmember that is a frame member, and hence the seat is fixed to the floor panel in a firmer manner.

In a fifth aspect, the vehicle may include a pair of rockers that extends in the vehicle front-rear direction along both side edges of the floor panel in the vehicle left-right direction in any of the first to fourth aspects. In this case, the first crossmember may extend between rear ends of the pair of rockers. According to the configuration as above, the first crossmember forms a frame of the vehicle with the pair of rockers, and hence it becomes possible to support the seat in a more stable manner. When a side collision occurs in the vehicle, the first crossmember functions as a transmission route (so-called load path) that transmits a load at the time of a side collision transmitted from one rocker in the left-right direction. The load transmitted to the first crossmember is transmitted to the second crossmember via the joining member, and hence it becomes possible to improve the strength of the vehicle against a side collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a configuration of a vehicle 10 of an example;

FIG. 2 is an upper view for describing the structure of the vehicle 10;

FIG. 3 is a view for showing a configuration of a vehicle body 12 in which the illustration of a floor panel 22 is omitted;

FIG. 4 is an enlarged view of a IV part in FIG. 3 in which the illustration of the floor panel 22 is omitted;

FIG. 5 is a sectional view taken along line V-V in FIG. 3; and

FIG. 6 is a bottom view for describing the structure of the vehicle 10.

### DETAILED DESCRIPTION OF EMBODIMENTS

A vehicle 10 of an example is described with reference to the drawings. The vehicle 10 of the present example belongs to an electrified vehicle having a motor 16 that drives wheels 14f, 14r and is typically an electrified vehicle (so-called automobile) that travels a road surface. However, a part or all of a technology described in the present example can also be similarly applied to an electrified vehicle that travels on a track. The vehicle 10 is not limited to a vehicle driven and operated by a user and may be a vehicle remotely operated by an external apparatus or a vehicle that autonomously travels.

Here, a direction FR in the drawings indicate the front side in a front-rear direction (or a length direction) of the vehicle 10, and a direction RR indicates the rear side in the front-rear direction of the vehicle 10. A direction LH indicates the left side in a left-right direction (or a width direction) of the vehicle 10, and a direction RH indicates the right side in the left-right direction of the vehicle 10. A direction UP indicates the upper side in an up-down direction (or a height direction) of the vehicle 10, and a direction DW indicates the lower side in the up-down direction of the vehicle 10.

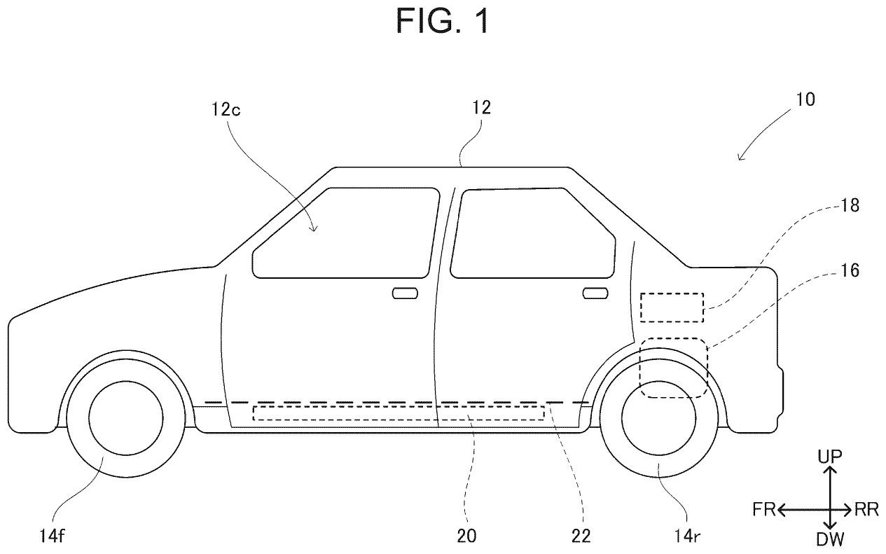

As shown in FIG. 1, the vehicle 10 includes a vehicle body 12 and a plurality of wheels 14f, 14r. The vehicle body 12 has a vehicle cabin 12c that is a space that carries an occupant. The plurality of wheels 14f, 14r is rotatably attached to the vehicle body 12. The plurality of wheels 14f, 14r includes the pair of front wheels 14f positioned in a front portion of the vehicle body 12 and the pair of rear wheels 14r positioned in a rear portion of the vehicle body 12. The pair of front wheels 14f is disposed to be coaxial with each other, and the pair of rear wheels 14r is also disposed to be coaxial with each other. The number of the wheels 14f, 14r is not limited to four. Although not particularly limited, the vehicle body 12 is configured by metal such as a steel material or aluminum alloy.

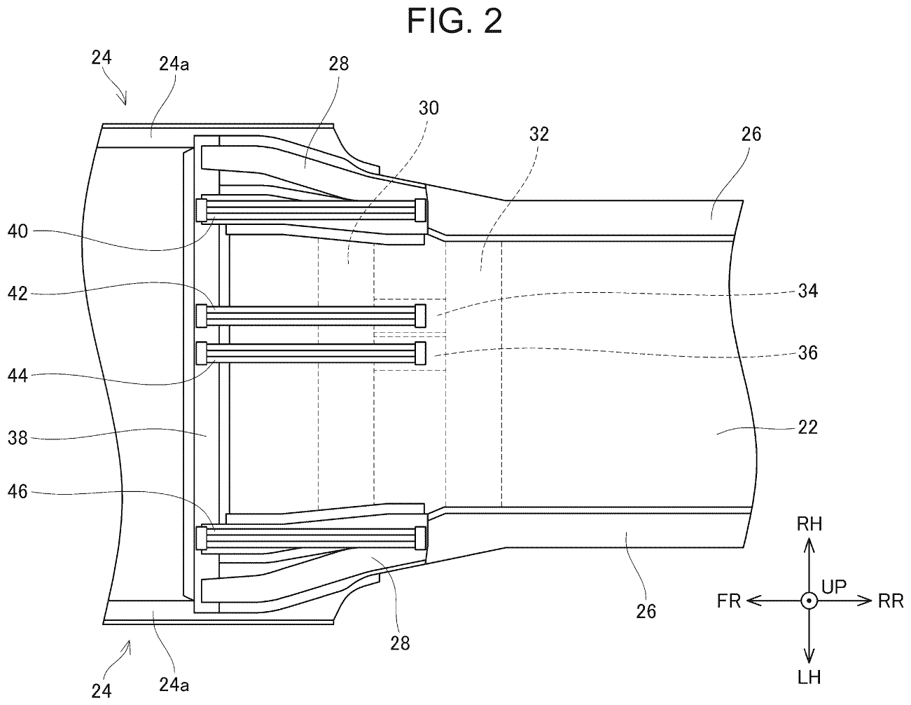

As shown in FIGS. 1 and 2, the vehicle 10 further includes a motor 16, an electricity control unit 18, and a battery pack 20. The motor 16 is a traveling motor that drives the pair of rear wheels 14r and is connected to the pair of rear wheels 14r. The battery pack 20 is a power source apparatus that supplies electricity to the motor 16 and is electrically connected to the motor 16 via the electricity control unit 18. The battery pack 20 has a plurality of secondary battery cells built therein, and is configured to be repeatedly chargeable by external electricity and regenerative electricity of the motor 16. The battery pack 20 is positioned below the floor panel 22 and is disposed along the floor panel 22. The electricity control unit 18 has a DC-DC converter and/or an inverter built therein and controls driving electricity supplied from the battery pack 20 to the motor 16 and regenerative electricity supplied from the motor 16 to the battery pack 20 in accordance with driving operation by the user, for example.

The motor 16 is not limited to being configured to drive the pair of rear wheels 14r and only needs to be configured to be able to drive at least one of the plurality of wheels 14f, 14r. The vehicle 10 may further include another prime mover such as an engine instead of or in addition to the motor 16. The vehicle 10 may include other power source apparatuses such as a fuel cell unit and a solar panel in addition to the battery pack 20. The vehicle 10 is not limited to the battery electric vehicle described here and may be a hybrid electric vehicle, a fuel cell electric vehicle, a solar car, or the like.

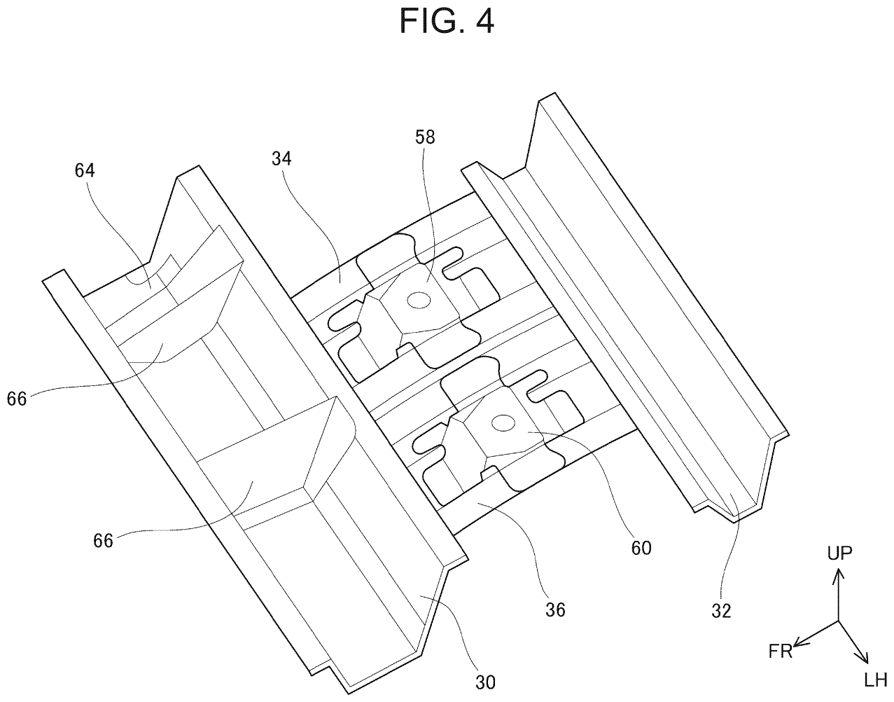

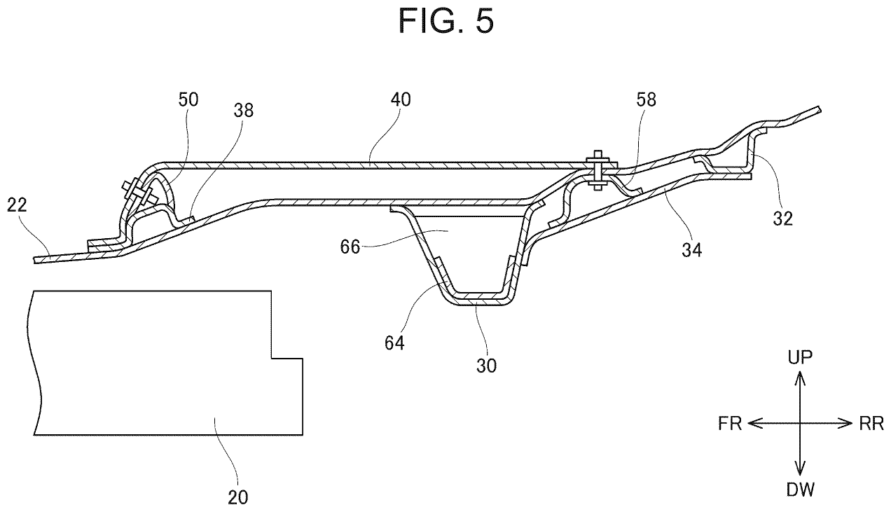

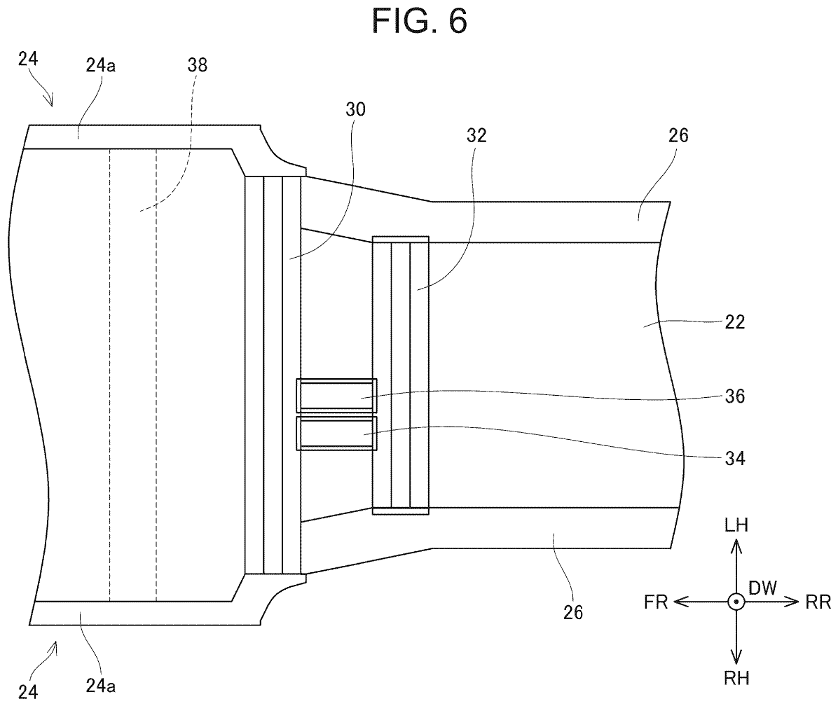

As shown in FIGS. 1 to 6, the vehicle body 12 includes the floor panel 22 and a pair of rockers 24. The floor panel 22 is a panel-like member configuring a bottom surface of the vehicle cabin 12c. Each of the pair of rockers 24 is a hollow member having a certain section along the vehicle length direction and configures a part of a frame in the vehicle body 12. The pair of rockers 24 is provided to be symmetrical to each other about the left-right direction of the vehicle 10. The pair of rockers 24 extends in the front-rear direction along both side edges of the floor panel 22 in the left-right direction. In other words, the floor panel 22 is provided between the pair of rockers 24.

Although not particularly limited, each of the pair of rockers 24 includes a rocker inner panel 24a and a rocker outer panel (not shown). The rocker inner panel 24a is positioned on the width-direction inner side, and the rocker outer panel is positioned on the width-direction outer side. The rocker inner panel 24a and the rocker outer panel are joined to each other at each upper edge and each lower edge thereof, and a closed space extending in the front-rear direction is formed on the inside of the rocker 24. However, in other embodiments, each rocker 24 is not limited to being configured by only the rocker inner panel 24a and the rocker outer panel, and may be configured by three or more panels.

As shown in FIGS. 2 to 6, the vehicle body 12 includes a pair of rear side members 26 and connecting members 28. Each of the pair of rear side members 26 is a hollow member extending along the vehicle length direction and configures a part of a frame in the vehicle body 12. The connecting member 28 is a member for connecting each rear side member 26 to the corresponding rocker 24. The pair of rear side members 26 is provided to be symmetrical to each other about the left-right direction of the vehicle 10. A front end portion of each rear side member 26 is connected to a rear end portion of the corresponding rocker 24 via the connecting member 28. As with the pair of rockers 24, the pair of rear side members 26 extends in the front-rear direction along both side edges of the floor panel 22. The vehicle body 12 does not necessarily need to include the connecting members 28. In other embodiments, each rear side member 26 may be directly connected to the corresponding rocker 24.

As shown in FIGS. 2 to 6, the vehicle body 12 further includes two under-floor crossmembers 30, 32. Each of the two under-floor crossmembers 30, 32 has a structure having a generally groove-shaped material (channel material) and has a generally U-like section opened to the upper side. The two under-floor crossmembers 30, 32 are positioned on the rear side of the battery pack 20 and extend in the left-right direction between the pair of rockers 24 along a lower surface of the floor panel 22. Although not particularly limited, each of the under-floor crossmembers 30, 32 is joined to the floor panel 22 by welding and the like. As a result, each of the under-floor crossmembers 30, 32 forms a closed space extending in the left-right direction of the vehicle 10 with the floor panel 22.

The two under-floor crossmembers 30, 32 include a first under-floor crossmember 30 and a second under-floor crossmember 32. The first under-floor crossmember 30 extends between rear ends of the pair of rockers 24. The second under-floor crossmember 32 is positioned rearward of the first under-floor crossmember 30 and extends between the pair of rear side members 26.

As shown in FIGS. 2 to 6, the vehicle body 12 further includes two joining members 34, 36. Each of the two joining members 34, 36 has a structure having a generally groove-shaped material (channel material) and has a generally U-like section opened to the upper side. The two joining members 34, 36 extend in the front-rear direction along the floor panel 22 and join the first under-floor crossmember 30 and the second under-floor crossmember 32 to each other. The two joining members 34, 36 include the first joining member 34 and the second joining member 36. The second joining member 36 is positioned leftward of the first joining member 34. Although not particularly limited, a front end portion of each of the joining members 34, 36 is joined to the first under-floor crossmember 30 by welding and the like, and a rear end portion of each of the joining members 34, 36 is joined to the second under-floor crossmember 32 by welding and the like.

As shown in FIGS. 2, 3, 5, and 6, the vehicle body 12 further includes an above-floor crossmember 38. The above-floor crossmembers 38 has a structure having a generally groove-shaped material (channel material) and has a substantially U-like section opened to the lower side. The above-floor crossmember 38 is positioned on the upper side of the battery pack 20 and extends in the left-right direction between the pair of rockers 24 along an upper surface of the floor panel 22. Therefore, the above-floor crossmember 38, the first under-floor crossmember 30, and the second under-floor crossmember 32 are positioned in the order from the front side to the rear side of the vehicle 10. Although not particularly limited, the above-floor crossmember 38 is joined to the floor panel 22 by welding and the like. As a result, the above-floor crossmember 38 forms a closed space extending in the left-right direction of the vehicle 10 with the floor panel 22.

As shown in FIG. 2, the vehicle 10 further includes a plurality of seat rails 40, 42, 44, 46. Each of the plurality of seat rails 40, 42, 44, 46 is a member for fixing a seat (not shown) on which the user sits such that the seat is slidable in the front-rear direction. The plurality of seat rails 40, 42, 44, 46 includes the first seat rail 40, the second seat rail 42, the third seat rail 44, and the fourth seat rail 46. The first seat rail 40 is positioned on the rightmost side in the vehicle 10, the second seat rail 42 is positioned between the first seat rail 40 and the third seat rail 44, the third seat rail 44 is positioned between the second seat rail 42 and the fourth seat rail 46, and the fourth seat rail 46 is positioned on the leftmost side in the vehicle 10. In other words, the first seat rail 40, the second seat rail 42, the third seat rail 44, and the fourth seat rail 46 are positioned in the order from the right side toward the left side of the vehicle 10.

As one example, a seat (not shown) disposed on the right side in the vehicle cabin 12c is slidably fixed to the first seat rail 40 and the second seat rail 42. Meanwhile, a seat (not shown) disposed on the left side in the vehicle cabin 12c is slidably fixed to the third seat rail 44 and the fourth seat rail 46. Here, the position of each of the seat rails 40, 42, 44, 46 in the left-right direction can be changed, as appropriate, in accordance with the seat disposed in the vehicle cabin 12c.

As shown in FIGS. 2 to 5, the vehicle 10 further includes a plurality of front-side seat brackets 48, 50, 52, 54. The front-side seat brackets 48, 50 are members for fixing front end portions of the corresponding seat rails 40, 42, 44, 46. The plurality of front-side seat brackets 48, 50, 52, 54 is provided on the above-floor crossmember 38. As a result, the front end portion of each of the seat rails 40, 42, 44, 46 is supported by the above-floor crossmember 38. The plurality of front-side seat brackets 48, 50, 52, 54 includes the first front-side seat bracket 48, the second front-side seat bracket 50, the third front-side seat bracket 52, and the fourth front-side seat bracket 54. The first front-side seat bracket 48 is positioned on the rightmost side in the vehicle 10, the second front-side seat bracket 50 is positioned between the first front-side seat bracket 48 and the third front-side seat bracket 52, the third front-side seat bracket 52 is positioned between the second front-side seat bracket 50 and the fourth front-side seat bracket 54, and the fourth front-side seat bracket 54 is positioned on the leftmost side in the vehicle 10. In other words, the first front-side seat bracket 48, the second front-side seat bracket 50, the third front-side seat bracket 52, and the fourth front-side seat bracket 54 are positioned in the order from the right side toward the left side of the vehicle 10.

As shown in FIGS. 2 to 5, the vehicle 10 further includes a plurality of rear-side seat brackets 56, 58, 60, 62. The rear-side seat brackets 56, 58, 60, 62 are members for fixing rear end portions of the corresponding seat rails 40, 42, 44, 46. The plurality of rear-side seat brackets 56, 58, 60, 62 includes the first rear-side seat bracket 56, the second rear-side seat bracket 58, the third rear-side seat bracket 60, and the fourth rear-side seat bracket 62. The first rear-side seat bracket 56 is positioned on the rear side of the first front-side seat bracket 48 and is provided in the connecting member 28 on the right side. The second rear-side seat bracket 58 is positioned on the rear side of the second front-side seat bracket 50 and is provided in the first joining member 34. As a result, a rear end portion of the second seat rail 42 is supported by the first joining member 34, the first under-floor crossmember 30, and the second under-floor crossmember 32. The third rear-side seat bracket 60 is positioned on the rear side of the third front-side seat bracket 52 and is provided in the second joining member 36. As a result, a rear end portion of the third seat rail 44 is supported by the second joining member 36, the first under-floor crossmember 30, and the second under-floor crossmember 32. The fourth rear-side seat bracket 62 is positioned on the rear side of the fourth front-side seat bracket 54 and is provided in the connecting member 28 on the left side.

As described above, each of the front-side seat brackets 48, 50, 52, 54 is provided on the above-floor crossmember 38. In other words, the positions of the front-side seat bracket 48, 50, 52, 54 in the front-rear direction are determined by the position of the above-floor crossmember 38 in the front-rear direction. Meanwhile, the position of the second rear-side seat bracket 58 in the front-rear direction is determined in accordance with the position of the second front-side seat bracket 50 in the front-rear direction and the length dimension of the second seat rail 42 in the front-rear direction. Regarding this point, the second rear-side seat bracket 58 is provided in the first joining member 34. Therefore, the position of the second rear-side seat bracket 58 in the front-rear direction can be freely set within a range of the length of the first joining member 34 extending in the front-rear direction. As above, the position of the second rear-side seat bracket 58 in the front-rear direction can be relatively freely set regardless of the position of each of the under-floor crossmembers 30, 32 in the front-rear direction. Similarly, the position of the third rear-side seat bracket 60 in the front-rear direction can also be relatively freely set regardless of the position of each of the under-floor crossmembers 30, 32 in the front-rear direction.

Although not particularly limited, each of the front-side seat bracket 48, 50, 52, 54 is joined to the above-floor crossmember 38 by welding and the like. The first rear-side seat bracket 56 is joined to the connecting member 28 on the right side by welding and the like, the second rear-side seat bracket 58 is joined to the first joining member 34 by welding and the like, the third rear-side seat bracket 60 is joined to the second joining member 36 by welding and the like, and the fourth rear-side seat bracket 62 is joined to the connecting member 28 on the left side by welding and the like.

In the vehicle 10 described above, the second rear-side seat bracket 58 to which a right-side seat (not shown) is fixed is provided in the first joining member 34 that joins the first under-floor crossmember 30 and the second under-floor crossmember 32 to each other. Similarly, the third rear-side seat bracket 60 to which a left-side seat (not shown) is fixed is provided in the second joining member 36 that joins the first under-floor crossmember 30 and the second under-floor crossmember 32 to each other. According to the configuration as above, seat fixing sections in the floor panel 22 are reinforced by each of the joining members 34, 36 and the two under-floor crossmembers 30, 32, and hence it becomes possible to reduce the deformation caused in the floor panel 22 and the like. When a side collision occurs in the vehicle 10 and a load is applied to one of the two under-floor crossmembers 30, 32 from the vehicle left-right direction, the load is also transmitted to the other of the under-floor crossmembers 30, 32 via each of the joining members 34, 36. Therefore, it becomes possible to improve the strength of the vehicle 10 against a side collision.

The first under-floor crossmember 30 in the present specification is one example of a first crossmember in the present technology, the second under-floor crossmember 32 in the present specification is one example of a second crossmember in the present technology, and the above-floor crossmember 38 in the present specification is one example of a third crossmember in the present technology. The second rear-side seat bracket 58 and the third rear-side seat bracket 60 in the present specification are one example of a seat bracket in the present technology, and the second front-side seat bracket 50 and the third front-side seat bracket 52 in the present specification are one example of a second seat bracket in the present technology.

The vehicle 10 does not necessarily need to include the plurality of seat rails 40, 42, 44, 46. In other embodiments, the seat on which the user sits may be directly fixed to each of the front-side seat brackets 48, 50, 52, 54 and the rear-side seat brackets 56, 58, 60, 62. The vehicle 10 does not necessarily need to include the plurality of seat brackets 48, 50, 52, 54, 56, 58, 60, 62. In other words, the vehicle 10 only needs to include at least one of the second rear-side seat bracket 58 or the third rear-side seat bracket 60 in the example described above.

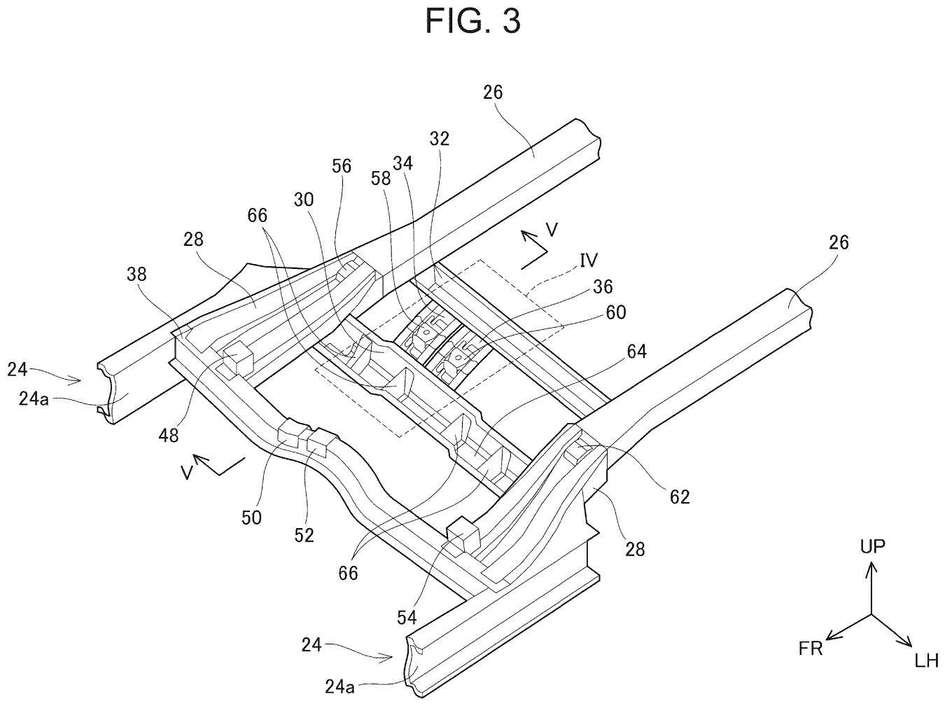

As one example, as shown in FIGS. 3 to 5, the first under-floor crossmember 30 further includes a reinforcement plate 64. The reinforcement plate 64 is a reinforcing member that improves the strength of the first under-floor crossmember 30. The reinforcement plate 64 is disposed along the left-right direction on the inside of the first under-floor crossmember 30. The reinforcement plate 64 is joined to the first under-floor crossmember 30 by welding and the like. As a result, the reinforcement plate 64 improves the strength of the first under-floor crossmember 30. According to the configuration as above, it becomes possible to improve the rigidity and the strength of the first under-floor crossmember 30. Therefore, it becomes possible to support the seat in a more stable manner, and it becomes possible to improve the absorption of the collision energy by the first under-floor crossmember 30 when a side collision occurs in the vehicle 10.

In addition to or instead of the above, as shown in FIGS. 3 to 5, the first under-floor crossmember 30 further includes bulks 66. The bulks 66 are reinforcing members that improve the strength of the first under-floor crossmember 30. The bulks 66 are plate-like members and are disposed in a direction that intersects with the left-right direction on the inside of the first under-floor crossmember 30. The bulks 66 are joined to the first under-floor crossmember 30 and/or the reinforcement plate 64 by welding and the like. As a result, the bulks 66 improve the strength of the first under-floor crossmember 30. It becomes possible to also improve the rigidity and the strength of the first under-floor crossmember 30 by the configuration as above. Therefore, it becomes possible to support the seat in a more stable manner, and it becomes possible to improve the absorption of the collision energy by the first under-floor crossmember 30 when a side collision occurs in the vehicle 10.

Although some specific examples have been described above in detail, those are merely exemplifications and do not limit the scope of claims. The technology described in the scope of claims includes those obtained by variously modifying and changing the specific examples exemplified above. The technical elements described in the present specification or the drawings exhibit a technical utility by itself or by being combined.

What is claimed is:

1. A vehicle, comprising:
a floor panel;
a first crossmember that extends in a vehicle left-right direction along the floor panel;
a second crossmember that extends in the vehicle left-right direction along the floor panel and is positioned rearward of the first crossmember in a vehicle front-rear direction;
a joining member that extends in the vehicle front-rear direction along the floor panel and joins the first crossmember and the second crossmember to each other; and
a seat bracket which is provided in the joining member and on which a seat for a user to sit on is fixed.

2. The vehicle according to claim 1, further comprising a battery pack positioned on a lower side of the floor panel in a vehicle-height direction, wherein the first crossmember and the second crossmember are positioned rearward of the battery pack in the vehicle front-rear direction and are provided along a lower surface of the floor panel.

3. The vehicle according to claim 2, further comprising a reinforcement plate disposed along the vehicle left-right direction on an inside of the first crossmember and joined to the first crossmember.

4. The vehicle according to claim 2, further comprising:
a third crossmember that extends in the vehicle left-right direction along an upper surface of the floor panel on an upper side of the battery pack in the vehicle-height direction; and
a second seat bracket which is provided in the third crossmember and on which the seat is fixed.

5. The vehicle according to claim 1, comprising a pair of rockers that extends in the vehicle front-rear direction along both side edges of the floor panel in the vehicle left-right direction, wherein the first crossmember extends between rear ends of the pair of rockers.
